(19) United States
(12) Patent Application Publication
(10) Pub. No.: US 2024/0198819 A1
(43) Pub. Date: Jun. 20, 2024

(54) LUGGAGE-COMPARTMENT-BOARD SUPPORT STRUCTURE

(71) Applicant: SUBARU CORPORATION, Tokyo (JP)

(72) Inventors: Hatsuhisa UEDA, Tokyo (JP); Suharu HOSHINO, Tokyo (JP)

(21) Appl. No.: 18/519,841

(22) Filed: Nov. 27, 2023

(30) Foreign Application Priority Data
Dec. 20, 2022 (JP) JP 2022-203288

(51) Int. Cl. B60L 50/64; B60R 5/04

(52) U.S. Cl. CPC B60L 50/64; B60R 5/044

(57) ABSTRACT

A luggage-compartment-board support structure includes a battery case, a lid, a battery pack, and a luggage compartment board. A battery is accommodated in the battery case. The lid is disposed above the battery case. The battery pack is disposed below a luggage compartment. The luggage compartment board is disposed above the battery pack. The lid includes an opening cover having a cavity that is in communication with an interior of the battery case. The luggage compartment board is supported by at least the opening cover.

### CROSS-REFERENCE TO RELATED APPLICATIONS

The present application claims priority from Japanese Patent Application No. 2022-203288 filed on Dec. 20, 2022, the entire contents of which are hereby incorporated by reference.

### BACKGROUND

The disclosure relates to a luggage-compartment-board support structure for supporting a luggage compartment board laid in a luggage compartment of a vehicle.

As a vehicle luggage compartment structure, there has been proposed a structure that includes storages and a floor board that opens and closes the storages (see, for example, Japanese Unexamined Patent Application Publication No. 2014-76742). In the structure, the storages are disposed on a floor of a luggage compartment, and the floor board is supported on edges that isolate the storages from each other.

### SUMMARY

An aspect of the disclosure provides a luggage-compartment-board support structure including a battery case, a lid, a battery pack, and a luggage compartment board. A battery is accommodated in the battery case. The lid is disposed above the battery case. The battery pack is disposed below a luggage compartment. The luggage compartment board is disposed above the battery pack. The lid includes an opening cover having a cavity that is in communication with an interior of the battery case. The luggage compartment board is supported by at least the opening cover.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a diagram illustrating an overview of the configuration of a vehicle;

FIG. 2 is a diagram illustrating the configuration of a luggage compartment;

FIG. 3 is a sectional view of a lower portion of the luggage compartment; and

FIG. 4 is a perspective view of a lid.

### DETAILED DESCRIPTION

In a hybrid automobile or an electric automobile, there is a case where a battery pack that supplies electricity to a motor serving as a driving source is disposed in a lower portion of a luggage compartment. In such an automobile, a luggage compartment board is disposed on the battery pack in such a manner that luggage and the like can be disposed on the luggage compartment board.

Consequently, when luggage or the like is disposed on the luggage compartment board, a load is applied to the luggage compartment board, and the load is transmitted to the battery pack disposed below the luggage compartment board. Accordingly, the load applied to the luggage compartment board may be appropriately supported.

It is desirable to appropriately support a luggage compartment board.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### 1. Overview of Configuration of Vehicle

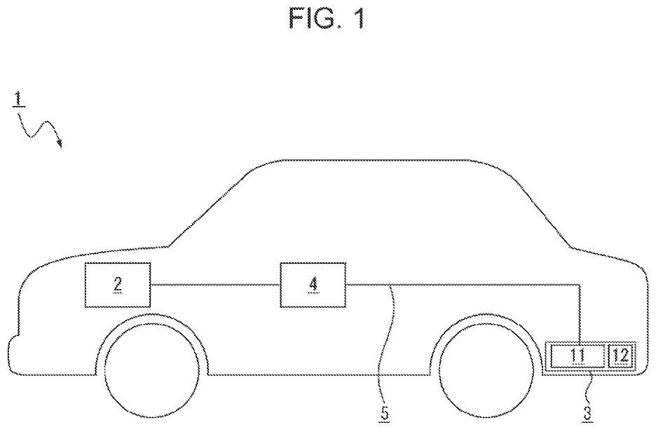

FIG. 1 is a diagram illustrating an overview of the configuration of a vehicle 1. The configuration of a principal portion according to the embodiment of the disclosure is extracted from the configuration of the vehicle 1 and is illustrated in FIG. 1.

The vehicle 1 of the present embodiment is an electric automobile or a hybrid automobile that includes a motor 2 serving as a power source. As illustrated in FIG. 1, the vehicle 1 includes the motor 2, a battery pack 3, an inverter 4, and a power transmission cable 5. The battery pack 3 includes a battery 11 and a battery control unit (BCU) 12.

The motor 2 is a power source that causes the vehicle 1 to travel and is, for example, a three-phase alternating-current motor. The motor 2 generates a driving force by receiving an electric power supplied from the battery 11 via the power transmission cable 5 and the inverter 4 and transmits the driving force to driving wheels so as to cause the vehicle 1 to travel. Note that, when the vehicle 1 is a hybrid automobile, the vehicle 1 also includes an engine serving as another power source.

The motor 2 generates electricity (electric power) by performing a regenerative operation. The electricity generated by the regenerative operation of the motor 2 is supplied to the battery 11 via the inverter 4 and the power transmission cable 5.

The battery 11 is a so-called high-voltage secondary battery and is capable of storing electricity that is to be supplied to the motor 2.

The inverter 4 converts a direct current supplied from the battery 11 into a three-phase alternating current and supplies the three-phase alternating current to the motor 2 via the power transmission cable 5. In addition, when the motor 2 performs the regenerative operation, the inverter 4 converts an alternating current supplied from the motor 2 into a direct current and supplies the direct current to the battery 11 via the power transmission cable 5.

The battery 11 can be charged by the regenerative operation of the motor 2. The battery 11 may also be charged by receiving electricity supplied from an external device (not illustrated).

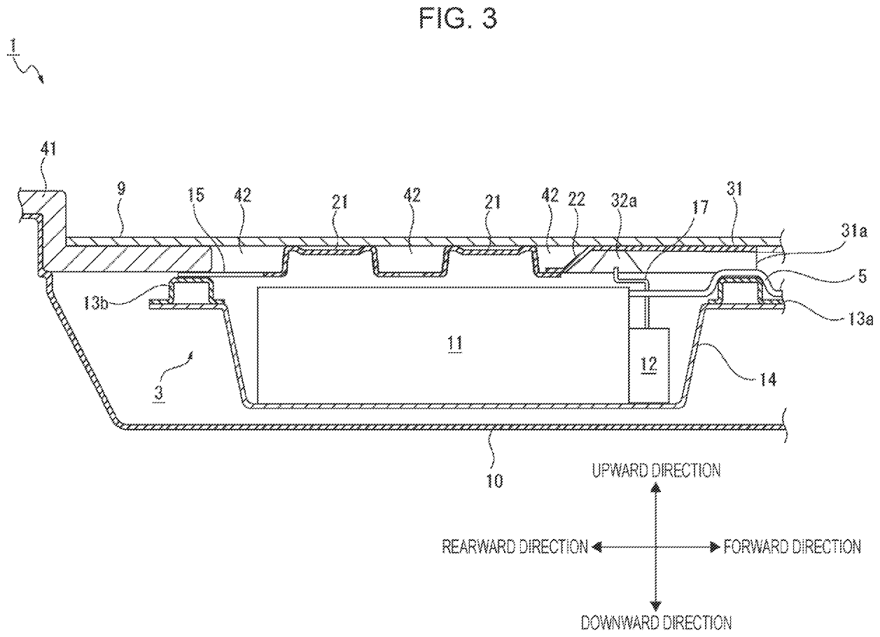

The BCU 12 is constituted by, for example, an electronic control unit (ECU). The BCU 12 monitors the state of the battery 11 and controls the operation of the battery 11. Sensors that measure the current, voltage, and temperature of the battery 11 are coupled to the BCU 12, and the BCU 12 acquires measurement results from these sensors. In addition, the BCU 12 transmits the measurement results acquired from the sensors to another ECU via a harness 17 (see FIG. 3) and controls the operation of the battery 11 based on the measurement results acquired from the sensors or an instruction from the other ECU.

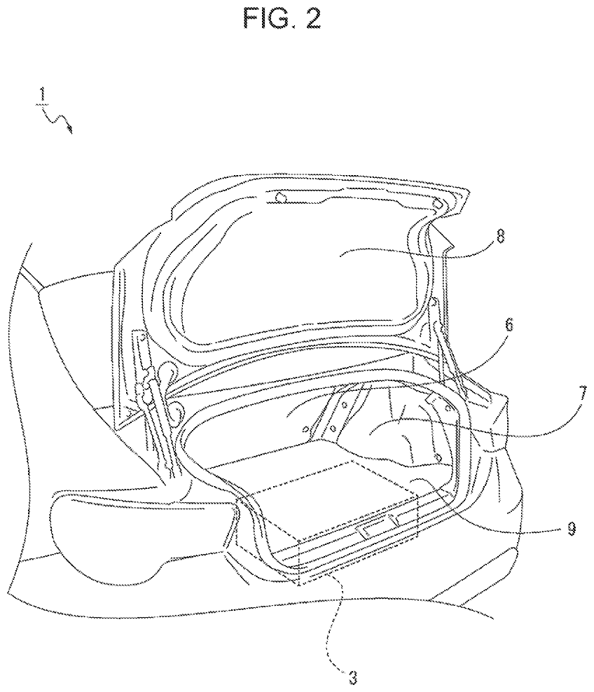

FIG. 2 is a diagram illustrating the configuration of a luggage compartment 7. As illustrated in FIG. 2, the vehicle 1 includes the luggage compartment 7 that is positioned behind a rear passenger seat 6. The luggage compartment 7 can be opened and closed by a rear hatch 8.

The battery pack 3 is disposed below the luggage compartment 7. A luggage compartment board 9 is disposed above the battery pack 3, and luggage and the like can be disposed above the luggage compartment board 9.

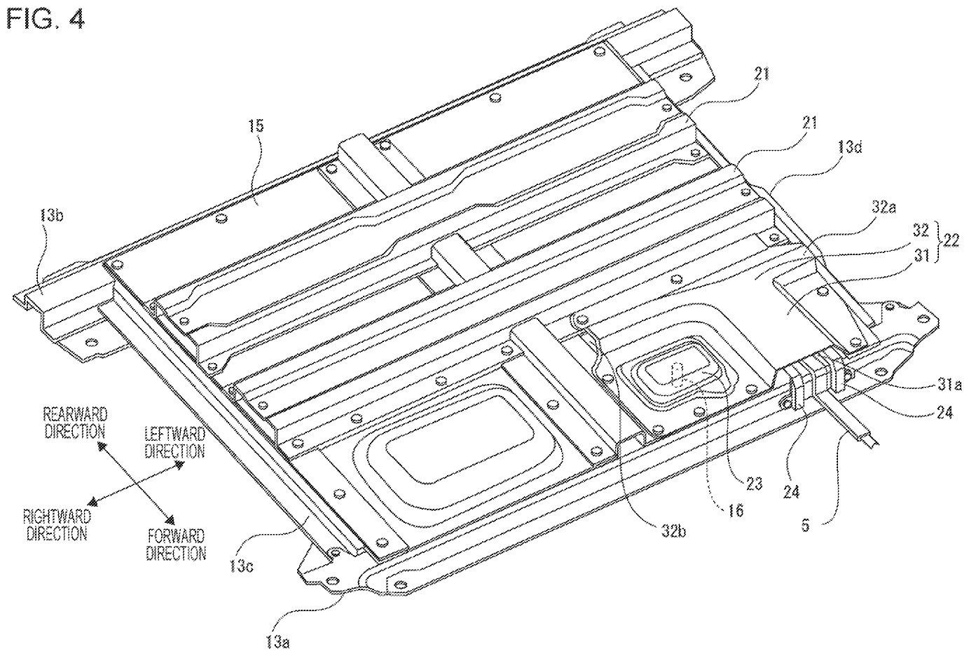

FIG. 3 is a sectional view of a lower portion of the luggage compartment 7. FIG. 4 is a perspective view of a lid 15. As illustrated in FIG. 3, a rear floor panel 10 that has a recessed shape with an upper opening is disposed below the luggage compartment board 9, and the battery pack 3 is accommodated in the rear floor panel 10 and fixed in place inside the rear floor panel 10.

The battery pack 3 includes, in addition to the battery 11 and the BCU 12, which have been mentioned above, case frames 13 (13a to 13d), a battery case 14, the lid 15, and a service plug 16.

The case frames 13 include two case frames 13a and 13b that are disposed along the lateral direction and two case frames 13c and 13d that are disposed along the longitudinal direction.

The case frames 13a and 13b are disposed so to be spaced apart from each other by a predetermined distance in the longitudinal direction. The case frames 13c and 13d are disposed so as to be spaced apart from each other by a predetermined distance in the lateral direction. The case frames 13a, 13b, 13c, and 13d are coupled to one another, so that, when seen as a whole, the case frames 13 have a substantially rectangular shape with a center opening.

The case frames 13 are made of, for example, a metal material such as aluminum. Each of the case frames 13 is substantially U-shaped and is open in the downward direction when viewed in cross section so as to improve the rigidity thereof. The battery pack 3 is fixed in place by fastening the case frames 13 to a vehicle body of the vehicle 1 with, for example, fastening bolts (not illustrated).

The battery case 14 is attached to lower portions of the case frames 13 by using, for example, fastening bolts (not illustrated). The battery case 14 has a recessed shape with an upper opening. The battery 11, the BCU 12, and the like are accommodated in the battery case 14.

A lid 15 is disposed on upper portions of the case frames 13 in such a manner as to cover the upper opening of the battery case 14. The lid 15 includes two frameworks 21, an opening cover 22, a plug cover 23, and two cable protectors 24.

Each of the frameworks 21 is disposed along the lateral direction such that both ends thereof are supported by the case frames 13c and 13d. Each of the frameworks 21 is substantially U-shaped and is open in the downward direction when viewed in cross section so as to improve the rigidity thereof.

The two frameworks 21 are disposed so to be spaced apart from each other in the longitudinal direction. One of the frameworks 21 is disposed substantially at the center of the lid 15 in the longitudinal direction. The other framework 21 is disposed behind the one framework 21.

The opening cover 22 and the plug cover 23 are disposed in front of the one framework 21. The opening cover 22 includes a cable cover 31 that extends along the longitudinal direction and a harness cover 32 that extends along the lateral direction. The cable cover 31 and the harness cover 32 are permanently affixed to each other. The opening cover 22 is substantially T shaped when seen as a whole.

The cable cover 31 and the harness cover 32 are each substantially U-shaped and is open in the downward direction when viewed in cross section so as to improve the rigidity thereof. In addition, the upper surface of the cable cover 31 and the upper surface of the harness cover 32 are continuous and flush with each other.

Due to its substantially U-shaped cross-section, the cable cover 31 has a cavity 31a that is open in the forward direction.

The cavity 31a is a space defined by the case frame 13a, which is positioned on the front side, and the cable cover 31 and is in communication with the interior of the battery case 14. The power transmission cable 5 is extended through the cavity 31a. One of the pair of cable protectors 24 is disposed on the right-hand side of the power transmission cable 5, and the other of the pair of cable protectors 24 is disposed on the left-hand side of the power transmission cable 5.

In the battery pack 3, since the power transmission cable 5 is extended on the case frame 13a so as to pass through the cavity 31a, even if water or the like enters the battery case 14, the probability that the power transmission cable 5 will become submerged, which in turn results in leakage of current, can be reduced.

In the cavity 31a, the power transmission cable 5 is disposed along the upper surface of the case frame 13a so as to extend in the longitudinal direction. In an area in front of the cavity 31a, the power transmission cable 5 is disposed along the front surface of the case frame 13a so as to extend in the vertical direction.

Each of the cable protectors 24 is substantially right-angled so as to extend in the vertical direction along the front surface of the case frame 13a and so as to extend in the rear direction from an upper end of the case frame 13a along the upper surface of the case frame 13a. Each of the cable protectors 24 has a thickness larger than the thickness of the power transmission cable 5.

Thus, when, for example, another vehicle or the like behind the vehicle 1 collides with the vehicle 1, causing the battery pack 3 to move forward, the cable protectors 24 are interpose between the lid 15 and a component disposed on the front side. Consequently, the cable protectors 24 can reduce the probability that the power transmission cable 5 will become damaged as a result of being sandwiched between the component on the front side and the lid 15 and will cause leakage of current.

Due to its substantially U-shaped cross-section, the harness cover 32 has a cavity 32a that is open in the leftward direction and a cavity 32b that is open in the rightward direction.

The cavity 32a is a space defined by the case frame 13d and the harness cover 32 and is in communication with the interior of the battery case 14. The harness 17 that is coupled to the BCU 12 is extended through the cavity 32a.

The cavity 32b is a space defined by the harness cover 32 and a portion of the lid 15 and is in communication with the interior of the battery case 14. The cavity 32b serves as an auxiliary space for passing a harness or the like therethrough.

The plug cover 23 is disposed in front of the right-hand side of the opening cover 22. The plug cover 23 is bowl-shaped with its center portion protruding in the upward direction so as to improve the rigidity of the plug cover 23. The plug cover 23 is detachably attached to other components of the lid 15. The service plug 16 is disposed inside the plug cover 23 and used for manually interrupting energization of the battery 11 during inspection or in an emergency. The plug cover 23 normally covers the service plug 16 in such a manner that the service plug 16 will not be manually operated.

The upper surfaces of the frameworks 21, the upper surface of the opening cover 22, and the upper surface of the plug cover 23 are approximately at the same level.

In the vehicle 1, a rear skirt trim 41 is disposed behind the battery pack 3 and defines the interior of a cavity of the luggage compartment 7. The front side of the rear skirt trim 41 is fixed to the case frame 13b of the battery pack 3, and the rear side of the rear skirt trim 41 is fixed to the rear floor panel 10.

The luggage compartment board 9 is disposed above the battery pack 3, so that the battery pack 3 is covered with the luggage compartment board 9. In this case, the luggage compartment board 9 is supported by the two frameworks 21, the opening cover 22, the plug cover 23, and the rear skirt trim 41. Note that a filler (not illustrated) such as, for example, expanded polystyrene is inserted into a space 42 between the luggage compartment board 9 and the lid 15.

The load applied to the luggage compartment board 9 as a result of luggage or the like being disposed on the luggage compartment board 9 is transmitted to the two frameworks 21, the opening cover 22, the plug cover 23, and the rear skirt trim 41, which support the luggage compartment board 9.

In this case, since the two frameworks 21, the opening cover 22, and the plug cover 23, which are included in the lid 15, are each shaped so as to have high rigidity as mentioned above, they can appropriately receive the load.

### 2. Modifications

Note that the above-described embodiment is an example for implementing the disclosure, and the disclosure is not limited to the above-described embodiment, and various modifications are possible.

For example, in the above-described embodiment, the upper surfaces of the frameworks 21, the upper surface of the opening cover 22, and the upper surface of the plug cover 23 are approximately at the same level. However, the upper surfaces of the frameworks 21, the upper surface of the opening cover 22, and the upper surface of the plug cover 23 may be at different levels. In the case where the upper surfaces are at different levels, a filler may simply be inserted into a space formed between the upper surfaces and the luggage compartment board 9. In other words, the frameworks 21, the opening cover 22, and the plug cover 23 may directly support the luggage compartment board 9 or may indirectly support the luggage compartment board 9 through the filler.

In the above-described embodiment, the luggage compartment board 9 is supported by the two frameworks 21, the opening cover 22, the plug cover 23, and the rear skirt trim 41. However, the luggage compartment board 9 may be supported by at least one component selected from the group consisting of one of the two frameworks 21, the other of the two frameworks 21, the opening cover 22, the plug cover 23, and the rear skirt trim 41. In this case, the luggage compartment board 9 may be supported by at least the opening cover 22.

The shapes of the two frameworks 21, the opening cover 22, and the plug cover 23, which have been mentioned in the above-described embodiment, are examples. Shapes that are different from those may be employed as long as the shapes enable the frameworks 21, the opening cover 22, and the plug cover 23 to receive the load applied to the luggage compartment board 9, that is, as long as the shapes improve the rigidities of the frameworks 21, the opening cover 22, and the plug cover 23.

In the above-described embodiment, although the upper surface of the cable cover 31 and the upper surface of the harness cover 32 are continuous and flush with each other, the upper surface of the cable cover 31 and the upper surface of the harness cover 32 may be at different levels.

### 3. Supplementary Note

As described above, the luggage-compartment-board support structure of the embodiment includes the battery case 14 in which the battery 11 is accommodated, the lid 15 disposed above the battery case 14, the battery pack 3 disposed below the luggage compartment 7, and the luggage compartment board 9 disposed above the battery pack 3. The lid 15 includes the opening cover 22 having the cavities 31a, 32a, and 32b that are in communication with the interior of the battery case 14. The luggage compartment board 9 is supported by at least the opening cover 22.

As a result, the load applied to the luggage compartment board 9 as a result of luggage or the like being disposed on the luggage compartment board 9 can be received by the opening cover 22.

In this case, for example, the lid 15 may have the cavity 31a in order to extend the power transmission cable 5 on the case frame 13a. In the luggage-compartment-board support structure, the luggage compartment board 9 can be supported by the opening cover 22, which defines part of the cavity 31a through which the power transmission cable 5 is extended, without providing an additional component for supporting the luggage compartment board 9.

Accordingly, the number of components included in the luggage-compartment-board support structure can be reduced, and the amount of the filler used in the luggage-compartment-board support structure can be reduced. Thus, in the luggage-compartment-board support structure, the luggage compartment board 9 can be appropriately supported.

The lid 15 includes the plug cover 23 that covers a predetermined plug (the service plug 16), and the luggage compartment board 9 is supported by at least the opening cover 22 and the plug cover 23.

The battery pack 3 is to be provided with the service plug 16 for interrupting energization of the battery 11. The service plug 16 is to be in an inoperable state because it is normally not operated manually. Consequently, the lid 15 includes the plug cover 23 that covers the service plug 16.

In the luggage-compartment-board support structure, the luggage compartment board 9 can be supported by the plug cover 23, which covers the service plug 16. Therefore, the number of components included in the luggage-compartment-board support structure can be reduced, and the luggage compartment board 9 can be appropriately supported without providing an additional component for supporting the luggage compartment board 9.

The opening cover 22 includes the cable cover 31 that has the cavity 31a through which the power transmission cable 5 that is coupled to the battery 11 is extended.

As a result, in the luggage-compartment-board support structure, the luggage compartment board 9 can be supported by the cable cover 31, which has the cavity 31a through which the power transmission cable 5 is extended. Therefore, the number of components included in the luggage-compartment-board support structure can be reduced, and the luggage compartment board 9 can be appropriately supported without providing an additional component for supporting the luggage compartment board 9.

The opening cover 22 includes the harness cover 32 that has the cavity 32a through which the harness 17 is extended. The harness 17 is coupled to an electronic device (the BCU 12) that is accommodated in the battery case 14. The cable cover 31 and the harness cover 32 are permanently affixed to each other.

As a result, the load applied to the luggage compartment board 9 as a result of luggage or the like being disposed on the luggage compartment board 9 can be received by the cable cover 31 and the harness cover 32.

In this case, the lid 15 may have the cavity 32a in order to extend the harness 17 on the case frame 13d. The luggage compartment board 9 can be supported by the harness cover 32, which has the cavity 32a through which the harness 17 is extended. Therefore, the number of components included in the luggage-compartment-board support structure can be reduced, and the luggage compartment board 9 can be appropriately supported without providing an additional component for supporting the luggage compartment board 9.

In addition, the cable cover 31 and the harness cover 32 are permanently affixed to each other, so that their rigidities can be improved. Therefore, the cable cover 31 and the harness cover 32 can each have further improved strength with respect to the load transmitted thereto from the luggage compartment board 9.

The direction in which the cable cover 31 extends and the direction in which the harness cover 32 extends cross each other.

For example, the direction in which the cable cover 31 extends and the direction in which the harness cover 32 extends are perpendicular to each other, so that the rigidities of the cable cover 31 and the harness cover 32 can be further improved. According to the disclosure, the luggage compartment board can be appropriately supported.

1. A luggage-compartment-board support structure comprising:
a battery case in which a battery is accommodated;
a lid disposed above the battery case;
a battery pack disposed below a luggage compartment; and
a luggage compartment board disposed above the battery pack,
wherein the lid comprises an opening cover having a cavity that is in communication with an interior of the battery case, and
wherein the luggage compartment board is supported by at least the opening cover.

2. The luggage-compartment-board support structure according to claim 1,
wherein the lid comprises a plug cover configured to cover a predetermined plug, and
wherein the luggage compartment board is supported by at least the opening cover and the plug cover.

3. The luggage-compartment-board support structure according to claim 1,
wherein the opening cover comprises a cable cover having a cavity through which a power transmission cable is extended, the power transmission cable being coupled to the battery.

4. The luggage-compartment-board support structure according to claim 2,
wherein the opening cover comprises a cable cover having a cavity through which a power transmission cable is extended, the power transmission cable being coupled to the battery.

5. The luggage-compartment-board support structure according to claim 3,
wherein the opening cover includes a harness cover having a cavity through which a harness is extended, the harness being coupled to an electronic device accommodated in the battery case, and
wherein the cable cover and the harness cover are permanently affixed to each other.

6. The luggage-compartment-board support structure according to claim 4,
wherein the opening cover includes a harness cover having a cavity through which a harness is extended, the harness being coupled to an electronic device accommodated in the battery case, and
wherein the cable cover and the harness cover are permanently affixed to each other.

7. The luggage-compartment-board support structure according to claim 5,
wherein a direction in which the cable cover extends and a direction in which the harness cover extends cross each other.

8. The luggage-compartment-board support structure according to claim 6,
wherein a direction in which the cable cover extends and a direction in which the harness cover extends cross each other.
